(19) United States
(12) Patent Application Publication
(10) Pub. No.: US 2014/0208642 A1
(43) Pub. Date: Jul. 31, 2014

(54) Grow Box and Method of Making a Grow Box

(71) Applicants: Shane Henman, Boulder, CO (US); Chad Barnets, Boulder, CO (US)

(72) Inventors: Shane Henman, Boulder, CO (US); Chad Barnets, Boulder, CO (US)

(21) Appl. No.: 14/167,980

(22) Filed: Jan. 29, 2014

Related U.S. Application Data
(60) Provisional application No. 61/758,252, filed on Jan. 29, 2013.

(51) Int. Cl. A01G 9/20

(52) U.S. Cl. CPC A01G 9/20
USPC 47/19.2; 29/428

(57) ABSTRACT

A grow box made from a box or cooler with a light enclosure and ventilation ducts for temperature regulation and circulation of air, and a timer for control of the light source. The grow box is sturdy, transportable, and stackable. A method for creating the grow box is included.

### CROSS-REFERENCE TO RELATED APPLICATION

The document is a non-provisional patent application claiming priority to, and the benefit of, U.S. Provisional Patent Application Ser. No. 61/758,252; filed Jan. 29, 2013, also entitled “Grow Box and Method of Making a Grow Box”, which is herein incorporated by reference in its entirety for all purposes.

### BACKGROUND OF THE INVENTION

1. Field of the Invention

The present invention is in the technical field of grow boxes. More particularly, the present invention pertains to the field of grow boxes containing lighting and ventilation systems.

2. Description of Related Art

A grow box is a partially or completely enclosed system for raising plants indoors or in small areas. Grow boxes are used for a number of reasons, including lack of available outdoor space or the desire to grow vegetables, herbs or flowers during cold weather months. They can also help protect plants against pests or disease.

Grow boxes may be soil-based or hydroponic. The most sophisticated examples are totally enclosed, and contain a built-in grow light, intake and exhaust fan system for ventilation, hydroponics systems that waters the plants with nutrient-rich solution, and an odor control filter. Some advanced grow box units even include air conditioning to keep running temperatures down, as well as CO₂ to boost the plant's growth rate. These advanced elements allow the gardener to maintain optimal temperature, light patterns, nutrition levels, and other conditions for the chosen plants. Key grow light options include fluorescent bulbs, which offer relatively limited light output; high intensity discharge (HID) bulbs such as high pressure sodium (HPS) and metal halide (MH) bulbs; or light-emitting diode (LED) bulbs, which are becoming more energy-efficient.

Grow boxes currently available require substantial time to put together, maintain, and take down again in order to transport. Additionally, they lack a rigid and durable frame, adequate insulation, and ability to be modularly stack upon each other. The present invention solves these problems in a new and economically efficient manner.

### SUMMARY

The scope of the present invention is defined solely by the appended claims and detailed description of a preferred embodiment, and is not affected to any degree by the statements within this summary.

The present invention is directed towards a means for growing plants in a box.

In embodiments of the present invention a grow box has an integrated lighting system that may be installed either under or through the top lid.

In embodiments of the present invention a grow box has an integrated ventilation system which may or may not include a means for draining water from the box.

In embodiments of the present invention a grow box has a clear enclosure that divides a light compartment from a plant compartment; such enclosure prevents heat gain in the plant compartment by facilitating ventilation in both the light and plant compartment.

In embodiments of the present invention, a grow box is structured such that it is stackable upon similar boxes and has handles for ease of transportation.

In embodiments of the present invention, a grow box with an insulated inner enclosure is described.

In embodiments of the present invention, a grow box with a light source that can be modified to work on a timer, by remote control, or programmed to turn on and off as the user desires is described.

Embodiments of the present invention comprise a method for making a grow box.

Embodiments of the present invention comprise a method for making a grow box out of a cooler.

### OBJECTS AND ADVANTAGES

The present disclosure can provide a number of advantages depending on the particular aspect, embodiment, and/or configuration. None of the particular objects or advantages that follow must be entirely satisfied as they are non-exclusive alternatives and at least one of the following objects is met; accordingly, several objects and advantages of the present invention are:
(a) to provide a grow box for plants;
(b) to provide a grow box with an integrated lighting system that may be installed either under or through the top lid;
(c) to provide a grow box with an integrated ventilation system which may or may not include a means for draining water from the box;
(d) to provide a grow box with a clear enclosure that divides a light compartment from a plant compartment; such enclosure preventing heat gain in the plant compartment by facilitating ventilation in both the light and plant compartment;
(e) to provide a grow box structured so that it is stackable upon similar boxes and has handles for ease of transportation;
(f) to provide a grow box with an insulated inner enclosure;
(g) to provide a grow box with a light source that can be modified to work on a timer, by remote control, or programmed to turn on and off as the user desires is described;
(h) to provide a method for making a grow box;
(i) to provide a method for making a grow box out of a cooler.

These and other objectives and advantages of the instant invention will become apparent from the following description taken in conjunction with the accompanying drawings wherein are set forth, by way of illustration and example, certain embodiments of the instant invention. The drawings are intended to constitute a part of this specification and include exemplary embodiments of the present invention and illustrate various objects and features thereof.

### BRIEF DESCRIPTION OF THE DRAWINGS

### 1. FIGURES

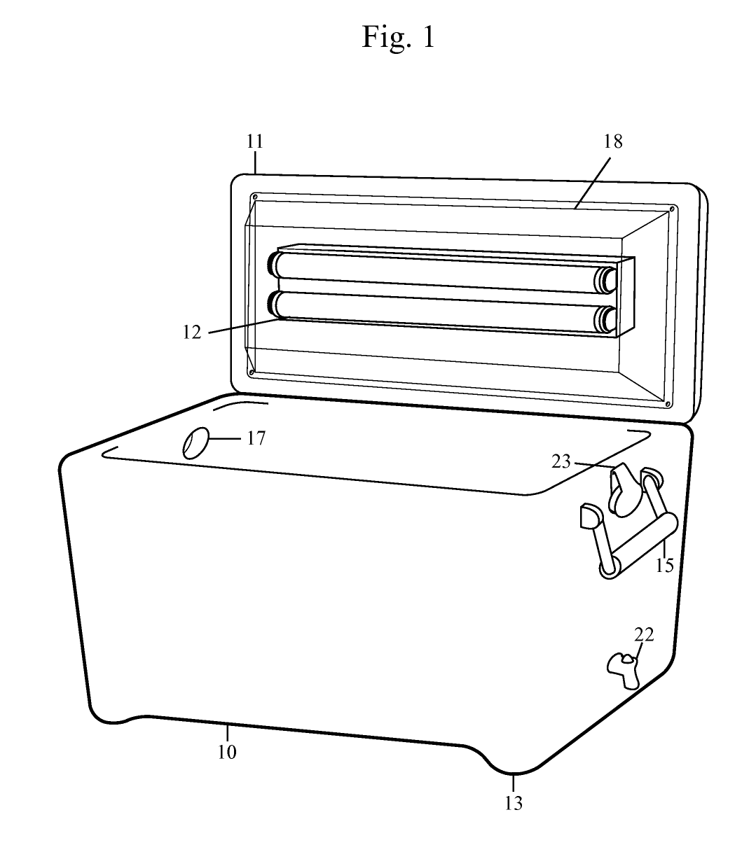

FIG. 1 (Sheet 1) illustrates a perspective view of a grow box with an open lid, according to embodiments of the present invention.

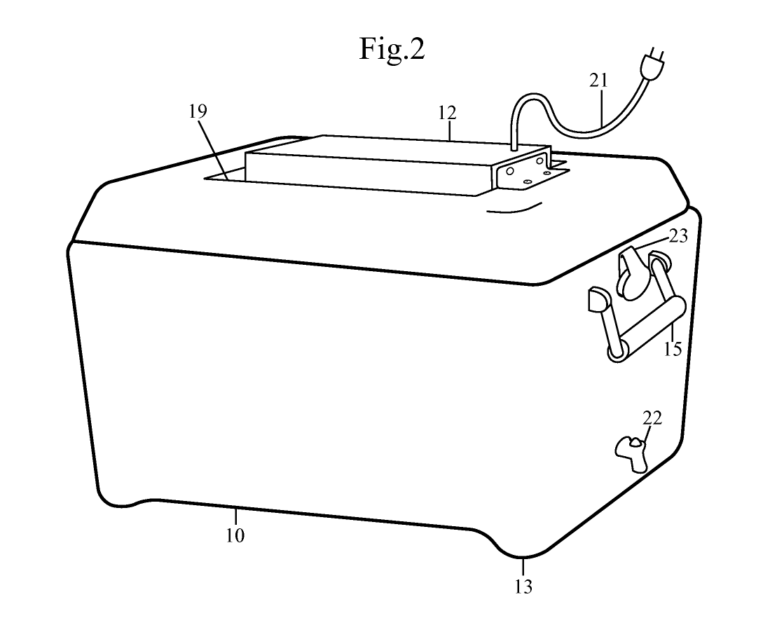

FIG. 2 (Sheet 2) illustrates a perspective view of a grow box with a closed lid, according to embodiments of the present invention.

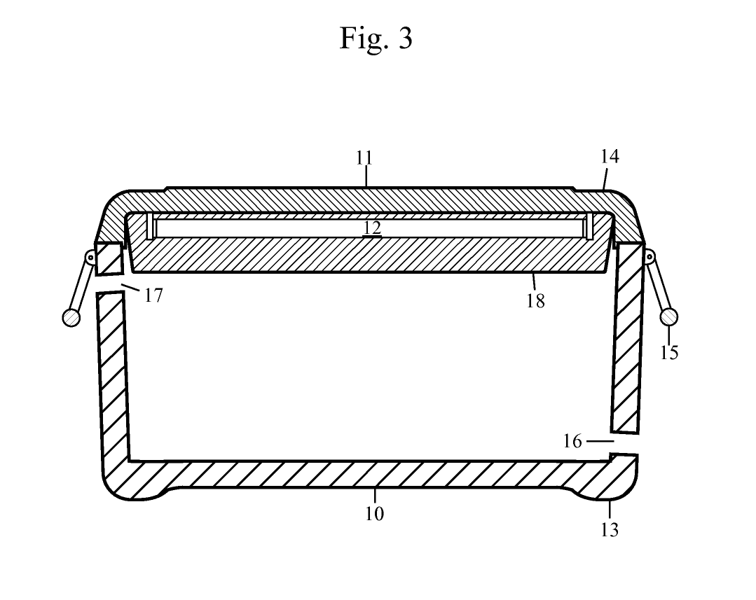

FIG. 3 (Sheet 3) illustrates a cross-section of a grow box, according to embodiments of the present invention.

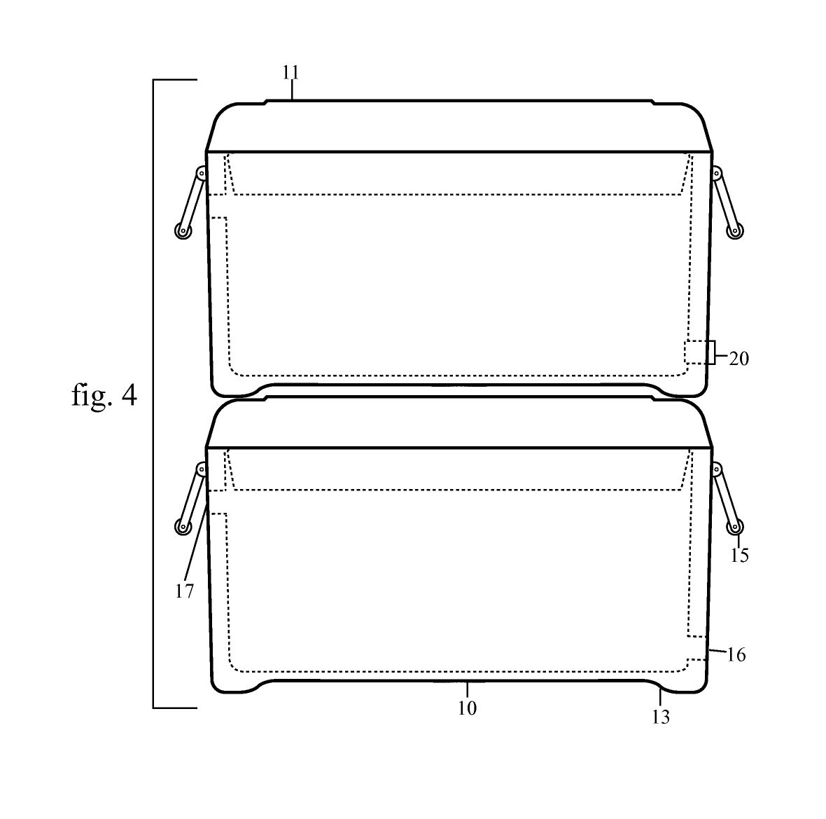

FIG. 4 (Sheet 4) illustrates a side view of two grow boxes stacked one upon the other, according to embodiments of the present invention.

### 2. REFERENCES

10 Grow box
11 Lid
12 Light
13 Bump on bottom of box
14 Recession on lid of box
15 Handle
16 Ventilation in lower side of box
17 Ventilation in upper side of box
18 Clear enclosure
19 Lid ventilation
20 Plug
21 Power cord
22 Spigot
23 Snap closure

### DETAILED DESCRIPTION OF A PREFERRED EMBODIMENT

For the purposes of promoting an understanding of the principles of the present invention, reference will now be made to the embodiments illustrated in the drawings and specific language will be used to describe the same. However, the illustrated embodiments are merely exemplary and many additional embodiments of this invention are possible. For example, the ventilating holes could be squares or located on different side of the box. It is understood that no limitation of the scope of the invention is thereby intended. Any alterations and further modifications in the illustrated devices, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

FIG. 1 illustrates a perspective view of a grow box (10) with an open lid (11). The lid (11) may be loose and set upon the box, attached by at least one hinge along one side, or attached by any means known in the art that facilitate economy of use; and may also have at least one handle for ease of opening. The lid (11) may also be fitted with at least one latch, catch, lock, bolt or any other means of securing a closure known in the art. The grow box (10) has at least one light source (12), which is usually separate from the grow box (10) and needs to be installed. The light source may be fluorescent bulbs, high intensity discharge (HID) bulbs such as high pressure sodium (HPS) and metal halide (MH) bulbs; light-emitting diode (LED) bulbs; or any other type of light emitting source capable of sustaining growth in plants. The light source (12) can be installed underneath the lid (11) of the grow box (10) or through the lid of the grow box as illustrated in FIG. 2. The light source (12) can be powered either by battery or by a power cord (21) as illustrated in FIG. 2. The light source may also have a power switch located on the light source, the box, or the cord. The light source can be modified to work on a timer, by remote control, or programmed to turn on and off as the user desires. The grow box (10) may also comprise handles (15) for ease of transport.

The grow box (10) may comprise one or more ventilation ducts. When the light source (12) is installed through the lid (11) it is easy to create lid ventilation (19) next to the light source (12) which is economical for the purpose of allowing heat from the light source (12) to rise upward via convection and leave the grow box (10). The grow box (10) may also have ventilation ducts on the upper (17) or lower (16) portion of one or more of the sides, such ventilation can be holes or ducts of any shape and size. The ventilation ducts may have closures such as a spigot (22), a snap closure (23), a plug (20), a cork, or any other closure known in the art. Placement of ventilation ducts near the top or the bottom of the box facilitates ventilation by allowing hot air to exit the box from the ventilation on the upper side of the box (17) and cold air to enter the box from the ventilation on the lower side of the box (16). Water used to hydrate the plants in the grow box may also be released from the box via the ventilation on the lower side of the box (16).

The grow box may also comprise a clear enclosure (18). The clear enclosure can be made of plastic, glass, or any other transparent material suitable for creating an enclosure that is permeable to light and impermeable to airflow. The clear enclosure (18) is attached to the lid (11) and is constructed such that when attached to the lid it fits into the box easily as the lid (11) is placed over the box (10). The clear enclosure (18) prevents heat gain in the box by creating a barrier to the circulation of air; which, when optionally combined with lid ventilation (19) allows heated air from the light source (12) to rise upward and leave the grow box (10). The clear enclosure (18) also works in conjunction with the ventilation ducts on the upper (17) or lower (16) portion of one or more of the sides. When the clear enclosure (18) extends downward it creates a barrier to air circulation in the grow box preventing the build-up of hot air below the clear enclosure (18) in the box, thus allowing hot air to more efficiently exit the box through the ventilation on the upper side of the box (17); which when combined with cold air entering the box from the ventilation on the lower side of the box (16) prevents heat gain and increase circulation of air which promotes growth in plants. Optimally, the clear enclosure (18) should extend downward to just above the ventilation on the upper side of the box (17), as pictured in FIG. 3 and FIG. 4. The clear enclosure (18) may also be loosely attached so that the user may conveniently put their hand between the clear enclosure (18) and the lid (11) to turn the light off

As illustrated in FIG. 4, the grow box (10) may also comprise a means for stacking Such means may include bumps (13) on the bottom of the grow box which fit into recessions (14) on the lid (11) of the box; such means may also be any other means known in the art. The grow box (10) may made of plastic, wood, metal, glass, Styrofoam, or any other material suitable to its purpose. The grow box (10) may also be insulated with an internal cavity filled with air, foam, or another insulating material. One preferred embodiment of the invention takes a standard cooler as its initial building component.

One embodiment of the present invention is a method for manufacturing a grow box (10) which may comprising one or more of the following steps, not necessarily performed in the order listed, unless the step listed must by virtue of fact be done prior to a subsequently listed step. First, you select a box. Second, you attach a light source (12) to the lid (11). Third, you attach a clear enclosure (18) over the light source (12) on the bottom of the lid (11). Fourth, you create one or more holes for ventilation through a side of the box near the bottom (16). Fifth, you create one or more holes for ventilation through a side of the box near the top (17). A preferred embodiment of the method uses a cooler as its initial box. Coolers are ideal boxes for grow boxes because they are durable, water tight, insulated, (in some case) stackable, and affordable. In a preferred embodiment of the method you cut a hole in the lid for ventilation (19) that is also the correct dimensions for installing the light source (12) through the lid (11). It is also possible to attach a means for controlling the activation of the light source based upon a timer to the light source.

### CONCLUSION

It is to be understood that while certain forms of the invention are illustrated, it is not to be limited to the specific forms or arrangements herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantage mentioned, as well as those inherent therein. The embodiments, methods, procedures, and techniques described herein are presently representative of the preferred embodiments; are intended to be exemplary; and are not intended as limitations on the scope. Changes therein and other uses will occur to those skilled in the art which are encompassed within the spirit of the invention and are defined by the scope of the claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the claims.

What is claimed is:

1. A grow box, comprising:
a box with four sides and a bottom;
a lid;
a light source;
a clear enclosure;
one or more ventilation holes through either the lid or sides of the box.

2. The grow box of claim 1, wherein the box is a cooler.

3. The grow box of claim 1, wherein there is one or more ventilation holes on the lid.

4. The grow box of claim 1, wherein a side of the box comprises at least one upper ventilation hole and a side of the box comprises at least one lower ventilation hole.

5. The grow box of claim 4, wherein said clear enclosure extends downward from the lid to just above said upper ventilation hole.

6. The grow box of claim 1, wherein said bottom of said box has at least one bump that fits into at least one recession of said lid, allowing the box to be stacked securely on top of another similar box.

7. The grow box of claim 1, further comprising a plug, spigot, or snap closure for said one or more ventilation holes through either the lid or sides of the box.

8. The grow box of claim 1, further comprising a means for controlling the activation of the light source based upon a timer.

9. The grow box of claim 1, further comprising a means for controlling the activation of the light source based upon a remote control.

10. A method for constructing a grow box, comprising the steps of:
selecting a box with four sides, a bottom, and a lid;
attaching a light source to the lid;
attaching a clear enclosure over the light source and under the lid;
creating one or more holes for ventilation through a side of the box near the top;
creating one or more holes for ventilation through a side of the box near the bottom.

11. The method for constructing the grow box of claim 10, wherein the box selected is a cooler.

12. The method for constructing the grow box of claim 10, additionally comprising creating one or more holes for ventilation through the lid.

13. The method for constructing the grow box of claim 12, wherein the light source is attached through a hole for ventilation through the lid.

14. The method for constructing the grow box of claim 12, wherein the clear enclosure extends downward close to one or more holes for ventilation through one or more sides of the box near the top.

15. The method for constructing the grow box of claim 10, additionally comprising attaching one or more plugs, spigots, or snap closures to one or more of said holes for ventilation through a side of the box near the top or bottom of said box.

16. The method for constructing the grow box of claim 10, further comprising attaching a means for controlling the activation of the light source based upon a timer.

17. The method for constructing the grow box of claim 10, further comprising attaching a means for controlling the activation of the light source based upon a remote control.
